(19) United States
(12) Patent Application Publication
(10) Pub. No.: US 2012/0326399 A1
(43) Pub. Date: Dec. 27, 2012

(54) Chuck

(76) Inventor: Jack LIN, (US)

(21) Appl. No.: 13/165,591

(22) Filed: Jun. 21, 2011

(51) Int. Cl. B23B 31/107; B23B 31/171

(52) U.S. Cl. 279/75

(57) ABSTRACT

Disclosed is a chuck including a rod, a ball, two spring-loaded pushers, and a spring-loaded sleeve. The rod includes a hexagonal pocket axially defined therein, a circular pocket axially defined therein so that it is in communication with the hexagonal pocket, and an aperture transversely defined therein so that it is in communication with the hexagonal pocket. The ball is movably located in the aperture so that the ball can be partially inserted in the hexagonal pocket. The first spring-loaded pusher is movably located in the circular pocket for pushing a bit. The spring-loaded sleeve is movably located on the rod for pushing the ball in a direction. The second spring-loaded pusher is movably located between the rod and the sleeve for pushing the ball in an opposite direction.

### BACKGROUND OF INVENTION

1. Field of Invention

The present invention relates to a chuck and, more particularly, to a convenient and reliable chuck.

2. Related Prior Art

Referring to FIG. 10, there is shown a conventional chuck similar to those disclosed in U.S. Pat. Nos. 4,900,202 and 5,013,194. The conventional chuck includes a rod 70, a sleeve 71 and two balls 74. The rod 70 includes a hexagonal pocket 72 axially defined in an end thereof and two apertures 73 transversely defined in the end thereof so that the hexagonal pocket 72 is in communication with the apertures 73. Each of the apertures 73 includes a small open end located near the hexagonal pocket 72 and an opposite large open end. The diameter of the large open ends of the apertures 73 is larger than that of the balls 74 while the diameter of the small open ends of the apertures 73 is smaller than that of the balls 74 so that each of the balls 74 can be moved into a related one of the apertures 73 through the large open end but cannot be completely moved out of the same through the small open end. Each of the balls 74 can however be partially moved out of a related one of the apertures 73 through the small open end. The sleeve 71 includes an annular groove defined in an internal side thereof and an annular shoulder 75 formed on the internal side thereof. The sleeve 71 is movably located on the rod 70 between a locking position and a releasing position. The sleeve 71 is biased to the locking position by a compressive helical spring provided on the rod 70. In the locking position, the annular shoulder 75 pushes the balls 74 on one side so that the balls 74 partially enter the hexagonal pocket 72 on an opposite side. Furthermore, each of the balls 74 partially enters an annular groove 61 defined in a bit 60, thus locking the bit 60 to the chuck. In the releasing position, the annular shoulder 75 is away from the balls 74 so that the balls 74 can leave the hexagonal pocket 72. The bit 60 can be pulled from the chuck as the bed of the annular groove 61 pushes the balls 74 out of the hexagonal pocket 72. It might be inconvenient to move the sleeve 71 to the releasing position with one hand and pull the bit 60 from the chuck with the other hand.

As disclosed in U.S. Pat. No. 6,325,393, another conventional chuck includes a spring-loaded follower located in the hexagonal pocket and abutted against the bit when the sleeve is in the locking position. When the sleeve is in the releasing position with one hand, the spring-loaded follower can push the bit out of the hexagonal pocket. The bit could however be ejected out of the hexagonal pocket by the spring-loaded follower and be lost.

The present invention is therefore intended to obviate or at least alleviate the problems encountered in prior art.

### SUMMARY OF INVENTION

It is an objective of the present invention to provide a convenient chuck.

It is another objective of the present invention to provide a reliable chuck.

To achieve the foregoing objectives, the chuck includes a rod, a ball, two spring-loaded pushers, and a spring-loaded sleeve. The rod includes a hexagonal pocket axially defined therein, a circular pocket axially defined therein so that it is in communication with the hexagonal pocket, and an aperture transversely defined therein so that it is in communication with the hexagonal pocket. The ball is movably located in the aperture so that the ball can be partially inserted in the hexagonal pocket. The first spring-loaded pusher is movably located in the circular pocket for pushing a bit. The spring-loaded sleeve is movably located on the rod for pushing the ball in a direction. The second spring-loaded pusher is movably located between the rod and the sleeve for pushing the ball in an opposite direction.

The chuck may further include a first spring for biasing the first pusher. The first pusher may include a tunnel defined therein for receiving a portion of the spring. The chuck may further include a magnet attached to the spring for attracting the bit.

The chuck may further including a second spring for biasing the second pusher. The chuck may further include a ring fit in the sleeve so that the second spring is compressed between the ring and the second pusher.

The sleeve may include an annular rib formed on an internal side thereof for retaining the second pusher therein and for keeping the ball in the aperture. The chuck may further include a washer secured to the rod and a spring compressed between the annular rib and a washer. The chuck may further include a C-clip secured to the rod for abutment against the washer.

Other objectives, advantages and features of the present invention will be apparent from the following description referring to the attached drawings.

### BRIEF DESCRIPTION OF DRAWINGS

The present invention will be described via detailed illustration of two embodiments versus the prior art referring to the drawings wherein:

FIG. 1 is an exploded view of a chuck according to the first embodiment of the present invention;

FIG. 2 is a cut-away view of the chuck shown in FIG. 1;

FIG. 3 is a cross-sectional view of the chuck shown in FIG. 2;

FIG. 4 is a cross-sectional view of the chuck in another position than shown in FIG. 3;

FIG. 5 is a cross-sectional view of the chuck in another position than shown in FIG. 4;

FIG. 6 is a cross-sectional view of the chuck in another position than shown in FIG. 5;

FIG. 7 is a view of the chuck in engagement with another bit other than shown in FIGS. 3 through 6;

FIG. 8 is a cross-sectional view of a chuck according to the second embodiment of the present invention;

FIG. 9 is a cross-sectional view of the chuck in another position than shown in FIG. 8; and

FIG. 10 is a cross-sectional view of a conventional chuck.

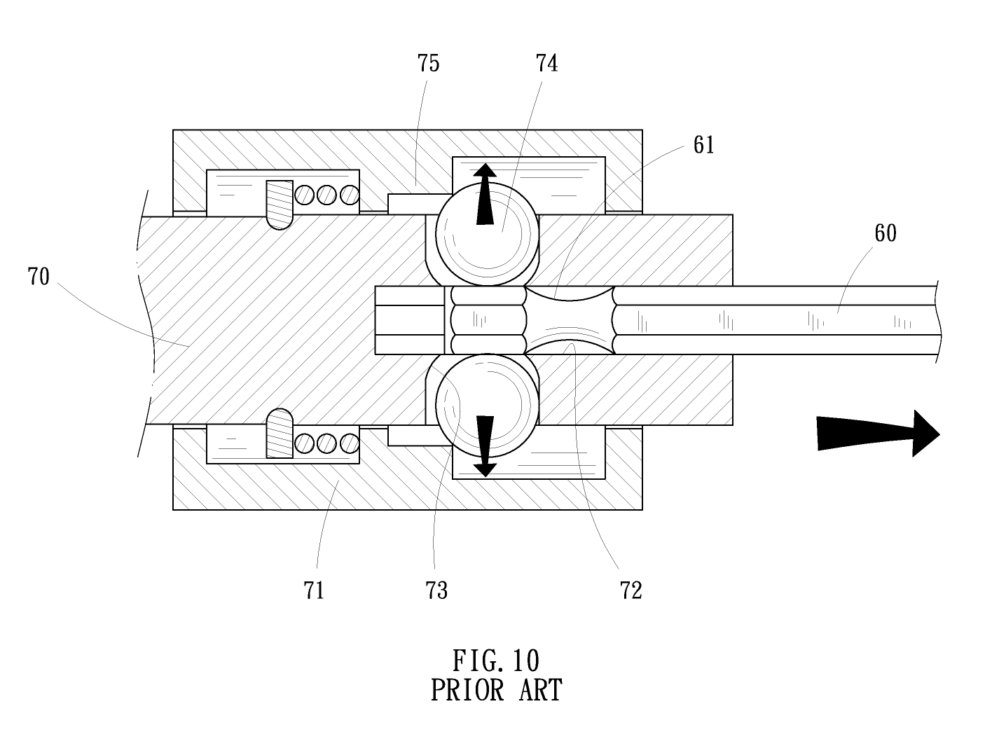

### DETAILED DESCRIPTION OF EMBODIMENTS

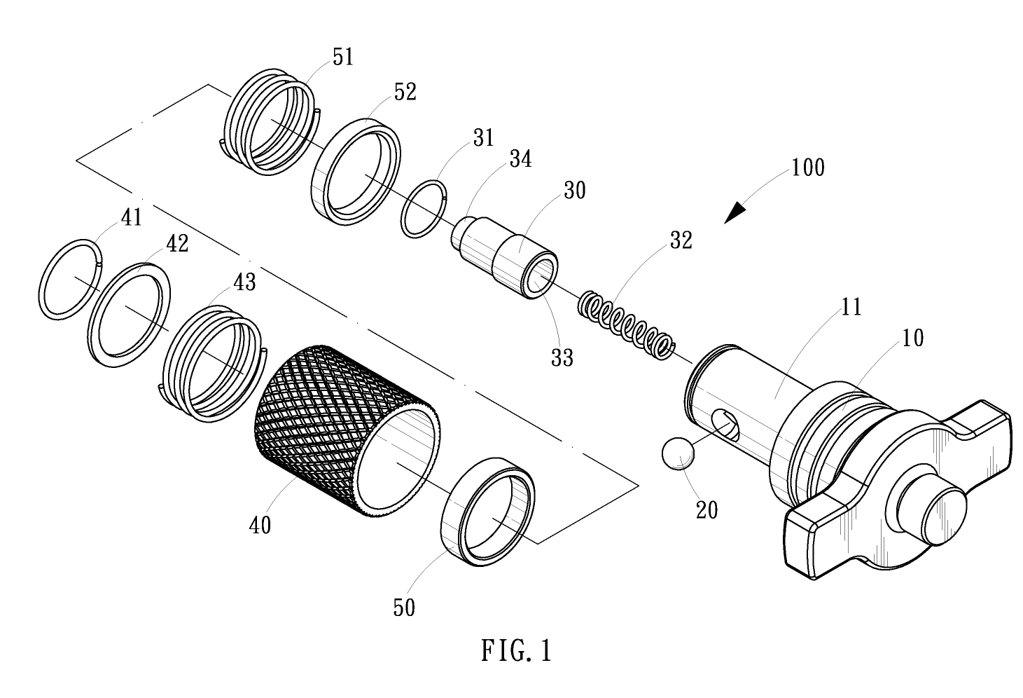

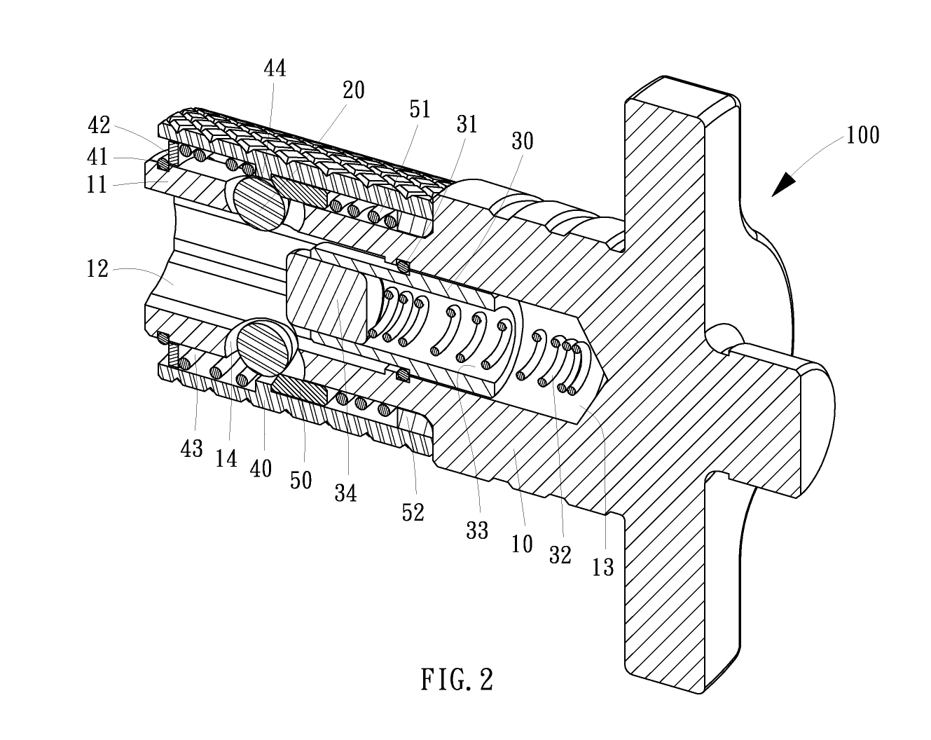

Referring to FIGS. 1 and 2, there is shown a chuck 100 according to a first embodiment of the present invention. The chuck 100 includes a rod 10, two balls 20, two pushers 30 and 50, a sleeve 40, a ring 52, and three springs 32, 43 and 51. The rod 10 includes a hexagonal pocket 12 axially defined in an end 11 thereof, a circular pocket 13 axially defined therein so that it is in communication with the hexagonal pocket 12, and two apertures 14 transversely defined in the end 11 thereof so that they are in communication with the hexagonal pocket 12. There is an annular rib formed on the internal side of the rod 10 between the hexagonal pocket 12 and the circular pocket 13.

Each of the apertures 14 includes a small open end located near the hexagonal pocket 12 and an opposite large open end. The diameter of the balls 20 is smaller than the width of the large open ends of the apertures 14 while the diameter of the balls 20 is larger than the width of the small open ends of the apertures 14 so that each of the balls 20 can be moved into a related one of the apertures 14 through the large open end but cannot be completely moved out of the same through the small open end. Each of the balls 20 can however be partially moved out of a related one of the apertures 14 through the small open end.

The pusher 30 is a tubular element with a tunnel 33 axially defined therein. A magnet 34 is fit in an open end of the tunnel 33. The pusher 30 includes an annular shoulder formed on an internal side thereof so that the pusher 30 is divided into two sections on the external side thereof.

The sleeve 40 includes an annular rib 44 formed on the internal side thereof. The space defined in the sleeve 40 is divided into two portions by the annular rib 44.

In assembly, an end of the spring 32 is located in the tunnel 33 while another end of the spring 32 is located outside the tunnel 33. The spring 32 and the first section of the pusher 30 are located in the circular pocket 13. The second section of the pusher 30 is located in the hexagonal pocket 12. A C-ring 31 is located on the second section of the pusher 30. The C-ring 31 is located between the annular shoulder of the pusher 30 and the annular rib of the rod 10 so that the pusher 30 is retained in the hexagonal pocket 12 and the circular pocket 13. The spring 32 is compressed between the magnet 34 and a closed end of the circular pocket 13.

The balls 20 are located in the apertures 14. The pusher 50 is movably located in the sleeve 40. The second spring 51 is located in the sleeve 40. The ring 52 is fit in the sleeve 40 so that there is not movement of the ring 52 relative to the sleeve 40. The second spring 51 is compressed between the second pusher 50 and the ring 52. The sleeve 40 is movably located on the end 11 of the rod 10 between a locking position and a releasing position. The third spring 43 and a washer 42 are located between the end 11 of the rod 10 and the sleeve 40 in a radial direction of the rod 10. A C-clip 41 is fit in an annular groove defined in an external side of the end 11 of the rod 10 so that the ring 52, the second spring 51, the pusher 50, the third spring 43, the washer 42 and the sleeve 40 are retained on the end 11 of the rod 10. The annular rib 44 is located between the pusher 50 and the third spring 43 in an axial direction of the rod 10.

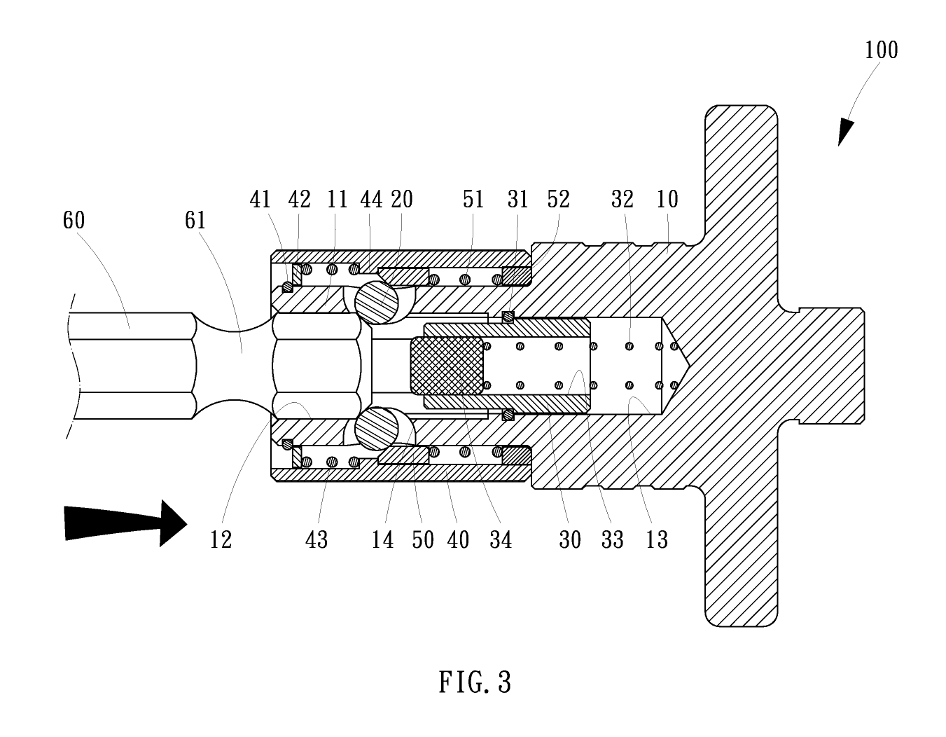

Referring to FIG. 3, there is shown a bit 60 in an early phase of insertion in the hexagonal pocket 12. An end of the bit 60 is just in contact with the balls 20. The bit 60 includes an annular groove 61 defined therein.

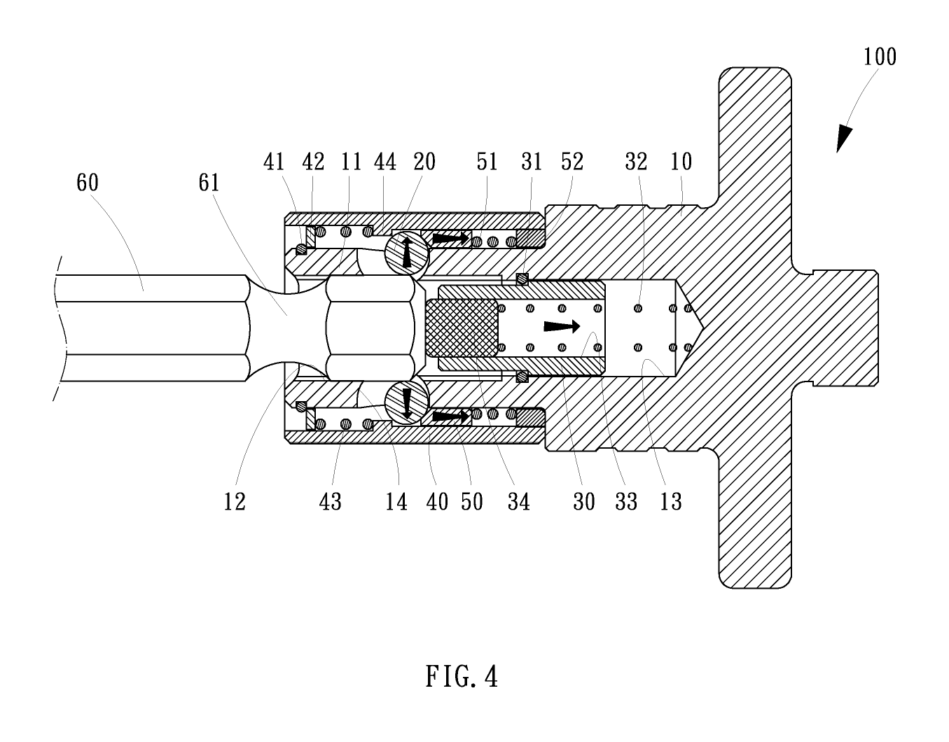

Referring to FIG. 4, the end of the bit 60 is inserted further into the hexagonal pocket 12. The balls 20 are moved out of the hexagonal pocket 12 against the second spring 51 while the first section of the pusher 30 is inserted further in to the circular pocket 13 against the first spring 32.

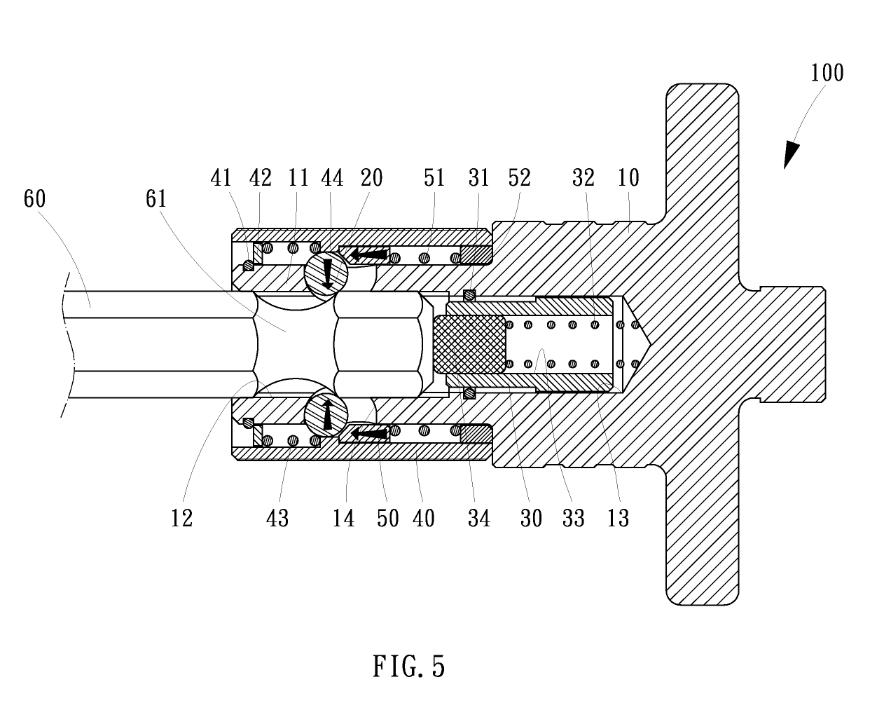

Referring to FIG. 5, the sleeve 40 is located in the locking position where the annular groove 61 is in communication with the apertures 14 so that each of the balls 20 is partially pushed into the annular groove 61 by the second spring 51 through the pusher 50. A portion of each of the balls 20 is abutted by the annular rib 44 so that another portion of the same is retained in the annular groove 61. Therefore, the bit 60 is locked to the chuck 100. Furthermore, each of the balls 74 partially enters an annular groove 61 defined in a bit 60, thus locking the bit 60 to the chuck 100.

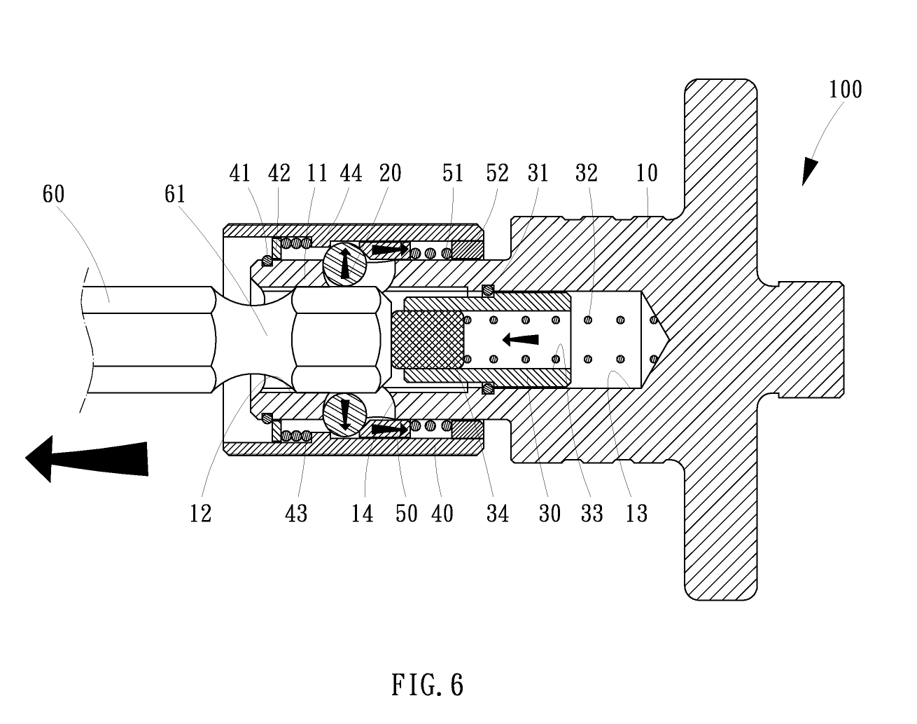

Referring to FIG. 6, the sleeve 40 is in the releasing position where the annular rib 44 is disengaged from the balls 20 so that the balls 20 can be moved out of the hexagonal pocket 12. The coefficient of elasticity of the first spring 32 is higher than that of the second spring 51 so that the first spring 32 pushes the bit 60 against the second spring 51. The bit 60 will not be ejected out of the hexagonal pocket 12 and get lost because it is attracted to the magnet 34.

The chuck 100 exhibits at least two advantages. At first, it is convenient since the first spring 32 automatically pushes the bit 60 against the second spring 51. Secondly, it is reliable since hexagonal pocket 12 because the magnet 34 attracts the bit 60 and hence prevents loss of the bit 60.

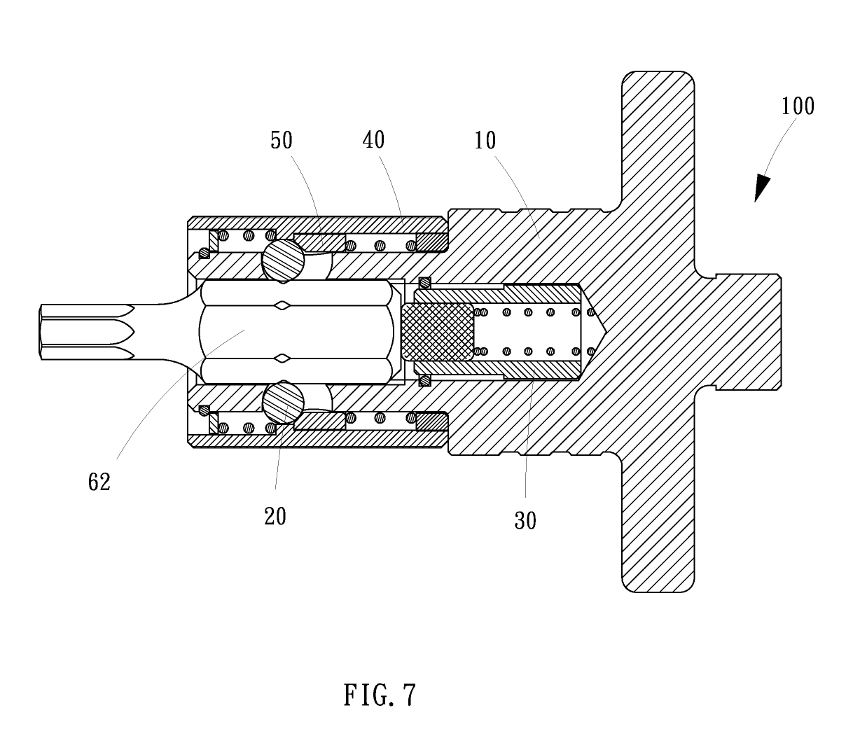

Referring to FIG. 7, another bit 62 is engaged with the chuck 100. The bit 62 includes six recesses instead of the annular groove 61. Each of the recess is defined in a corner of the bit 62.

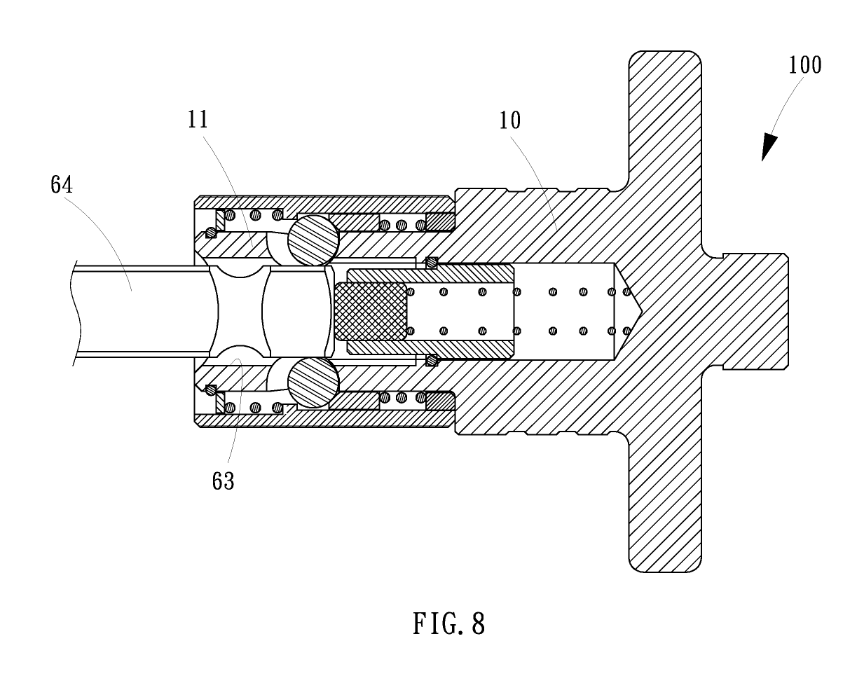

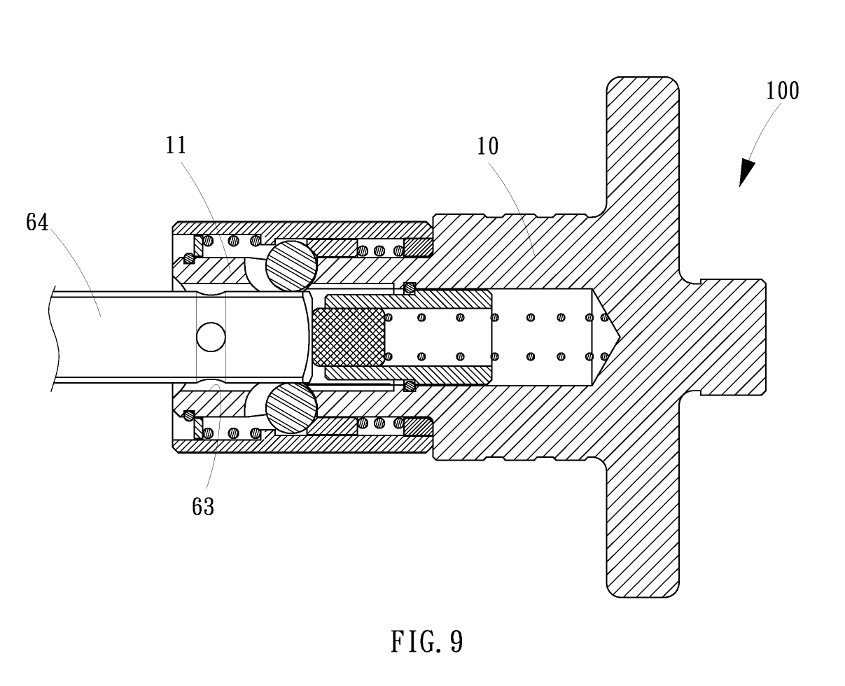

Referring to FIGS. 8 and 9, there is shown a chuck according to the second embodiment of the present invention. The second embodiment is like the first embodiment except that rod 10 includes a square pocket 63 instead of the hexagonal pocket 12. The square pocket 63 can receive a square bit 64.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A chuck including:
a rod including a hexagonal pocket axially defined therein, a circular pocket axially defined therein so that it is in communication with the hexagonal pocket, and an aperture transversely defined therein so that it is in communication with the hexagonal pocket;
a ball movably located in the aperture so that the ball can be partially inserted in the hexagonal pocket;
a first pusher movably located in the circular pocket for pushing a bit;
a sleeve movably located on the rod for pushing the ball in a direction; and;
a second pusher movably located between the rod and the sleeve for pushing the ball in an opposite direction.

2. The chuck according to claim 1, further including a spring for biasing the first pusher.

3. The chuck according to claim 2, wherein the first pusher includes a tunnel defined therein for receiving a portion of the spring

4. The chuck according to claim 2, further including a magnet attached to the spring for attracting the bit.

5. The chuck according to claim 1, further including a spring for biasing the second pusher.

6. The chuck according to claim 5, including a ring fit in the sleeve so that the spring is compressed between the ring and the second pusher.

7. The chuck according to claim 1, wherein the sleeve includes an annular rib formed on an internal side thereof for retaining the second pusher therein and for keeping the ball in the aperture.

8. The chuck according to claim 7, further including a washer secured to the rod and a spring compressed between the annular rib and a washer.

9. The chuck according to claim 8, further including a C-clip secured to the rod for abutment against the washer.
